(19) United States
(12) Patent Application Publication
(10) Pub. No.: US 2026/0142683 A1
(43) Pub. Date: May 21, 2026

(54) APPARATUSES FOR SECURELY STORING MOBILE ELECTRONIC DEVICES

(71) Applicant: YONDR, INC., Los Angeles, CA (US)

(72) Inventors: Anthony ABDELMALEK, Laguna Hills, CA (US); Kate Elizabeth ABDELMALEK, Laguna Hills, CA (US)

(21) Appl. No.: 18/954,596

(22) Filed: Nov. 21, 2024

(51) Int. Cl. H04B 1/3888

(52) U.S. Cl. CPC H04B 1/3888

(57) ABSTRACT

A device includes a first panel and a second panel, wherein the first panel and the second panel are connected together to define a container body with an opening. The container body is configured for storing one or more mobile electronic device(s), wherein the first panel includes a flap portion configured to fold over the opening to cover the opening and at least a part of the second panel. The first panel includes at least a portion of a locking mechanism configured to securely lock the flap portion to the second panel, thereby limiting access to the stored devices.

### FIELD

The following disclosure relates to apparatus for securely storing mobile devices.

### BACKGROUND

Use of handheld and mobile electronic devices is sometimes unwelcome. These devices can distract users from their surroundings and social interactions, as people often prioritize checking messages over engaging in live conversations. At events, recording performances with these devices can distract others and infringe on performers' intellectual property rights. Generally available methods to curb device usage can have limitations. Most systems can prevent users from receiving important notifications. Other methods, like signs or requiring devices to be turned off or handed over, are often ignored or resisted due to concerns over theft and missing important communications.

### SUMMARY

In some aspects, the techniques described herein relate to apparatuses for securely storing mobile electronic devices, wherein once secured, the access to the stored mobile electronic devices for their use becomes limited. Once securely stored, an external device is required to unlock the apparatuses to grant access to the mobile electronic devices.

In some aspects, the techniques described herein relate to an apparatus for securely storing one or more mobile electronic device(s), including: a first panel; a second panel, wherein the first panel and the second panel are connected together to define a container body with an opening, wherein the container body is configured for storing the one or more mobile electronic device(s), wherein the first panel includes a flap portion configured to fold over the opening to cover the opening and at least a part of the second panel, and the first panel includes at least a portion of a locking mechanism configured to securely lock the flap portion to the second panel.

In some aspects, the techniques described herein relate to an apparatus, wherein the portion of the locking mechanism is arranged at the flap portion.

In some aspects, the techniques described herein relate to an apparatus, wherein the second panel includes a mechanism configured to connect to the portion of the locking mechanism of the first panel.

In some aspects, the techniques described herein relate to an apparatus, wherein the first panel includes a container portion.

In some aspects, the techniques described herein relate to an apparatus, wherein the first panel includes a second container portion.

In some aspects, the techniques described herein relate to an apparatus, wherein the first panel includes a container portion with a transparent window.

In some aspects, the techniques described herein relate to an apparatus, wherein the second panel includes a container portion.

In some aspects, the techniques described herein relate to an apparatus, wherein the second panel includes a second container portion.

In some aspects, the techniques described herein relate to an apparatus, wherein the second panel includes a container portion with a transparent window.

In some aspects, the techniques described herein relate to an apparatus, wherein the first panel includes a mesh material.

In some aspects, the techniques described herein relate to an apparatus, wherein the second panel includes a mesh material.

In some aspects, the techniques described herein relate to an apparatus, wherein the second panel includes a perforated material.

In some aspects, the techniques described herein relate to an apparatus, further including an elastic strap connected to the second panel.

In some aspects, the techniques described herein relate to an apparatus, wherein the elastic strap forms or is a part of a weave pattern.

### BRIEF DESCRIPTION OF THE DRAWINGS

The accompanying drawings illustrate a number of example embodiments and are a part of the specification. Together with the following description, these drawings demonstrate and explain various principles of the present disclosure.

FIG. 1 illustrates a schematic diagram of an example configuration of an apparatus for storing mobile devices, according to some embodiments.

FIG. 2 illustrates a front view of an example configuration of an apparatus for storing mobile devices, according to some embodiments.

FIG. 3A and FIG. 3B illustrate example configurations of an apparatus for storing mobile devices, according to some embodiments.

FIG. 4 illustrates a schematic diagram of an example configuration of an apparatus for storing mobile devices, according to some embodiments.

FIG. 5 illustrates a schematic diagram of an example configuration of an apparatus for storing mobile devices, according to some embodiments.

FIG. 6A and FIG. 6B illustrate example configurations of an apparatus for storing mobile devices, according to some embodiments.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed.

### DETAILED DESCRIPTION

The accompanying drawings illustrate several example embodiments and are a part of the specification. Together with the following description, these drawings demonstrate and explain various principles of the present disclosure.

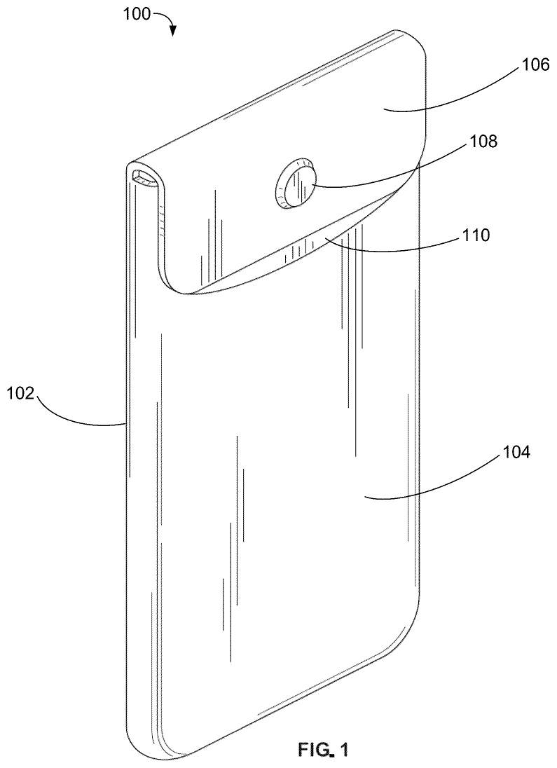

FIG. 1 is an exemplary schematic diagram of an apparatus 100 configured for securely storing one or more mobile electronic device(s). The apparatus 100 includes a first panel 102 connected to a second panel 104 to form a body which has an opening at the top of the apparatus 100. The first panel 102 is longer than the second panel 104 such that there is a flap portion 106 which extends above the length of the second panel 104. The flap portion 106 is configured to be foldable over the opening. When the flap portion 106 is folded, it covers the opening and overlaps at least a portion of the second panel 104. A locking mechanism 108 located at the flap portion 106 engages with a corresponding component located on the second panel 104 to securely close and lock the apparatus 100, such that access to the opening of the apparatus 100 is limited. That is, devices contained within the apparatus 100 is not accessible once the locking mechanism 108 is securely engaged and locked. The flap portion 106 includes a lip portion 110 which can be configured for easy gripping. For example, the lip portion 110 can be of a different material than the flap portion 106 or have a textured surface that is different from the material of the flap portion 106.

According to some embodiments, one or both of the first panel 102 and second panel 104 can be made of the same material. According to some embodiments, one or both of the first panel 102 and second panel 104 can be made of opaque material. According to some embodiments, one or both of the first panel 102 and second panel 104 can be made of mesh material. According to some embodiments, one or both of the first panel 102 and second panel 104 can include a transparent window. According to some embodiments, one or both of the first panel 102 and second panel 104 can include a perforated material.

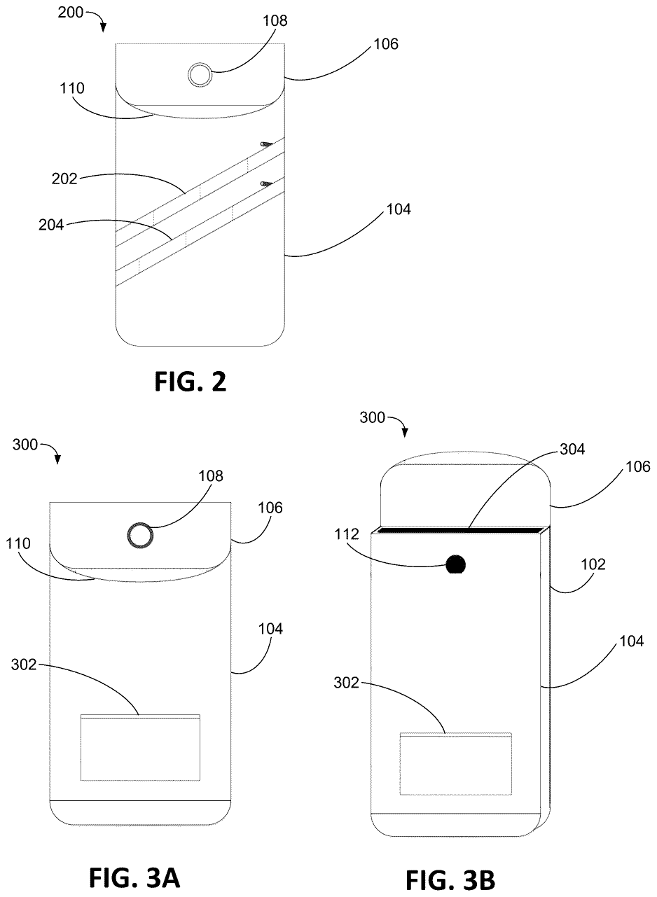

FIG. 2 shows a front view of an apparatus 200 according to some embodiments. The apparatus 200 includes similar components as the apparatus 100 illustrated in FIG. 1. That is, the apparatus 200 includes a panel 104 and a flap portion 106, along with the locking mechanism 108 and lip portion 110, as described above. The panel 104 of the apparatus 200 includes additional container portions 202, 204. Each of the container portions 202, 204 include respective zippers to be able to securely close the container portions 202, 204. According to some embodiments, additional features, such as elastic bands can be included on the panel 104 of apparatus 200.

FIG. 3A and FIG. 3B show alternate configurations of another example of an apparatus 300, which is configured for securely storing mobile electronic devices. FIG. 3A illustrates a closed apparatus 300, wherein the flap portion 106 is positioned in a closed state that securely closes off the access to the interior of the apparatus 300. The locking mechanism 108 being engaged when the apparatus 300 is in a securely locked state. Additionally, the panel 104 includes a container portion 302 which can be configured to hold, for example, identification card(s). According to some embodiments, the container portion 302 includes a transparent window to be able to view the contents contained within it. FIG. 3B shows the apparatus 300 in an open state, where the flap portion 106 is in the open position. In this open state, the opening 304 is visible and accessible. The panel 104 includes a portion or a component of the locking mechanism 112 which is configured to engage with the locking mechanism 108 on the flap portion 106.

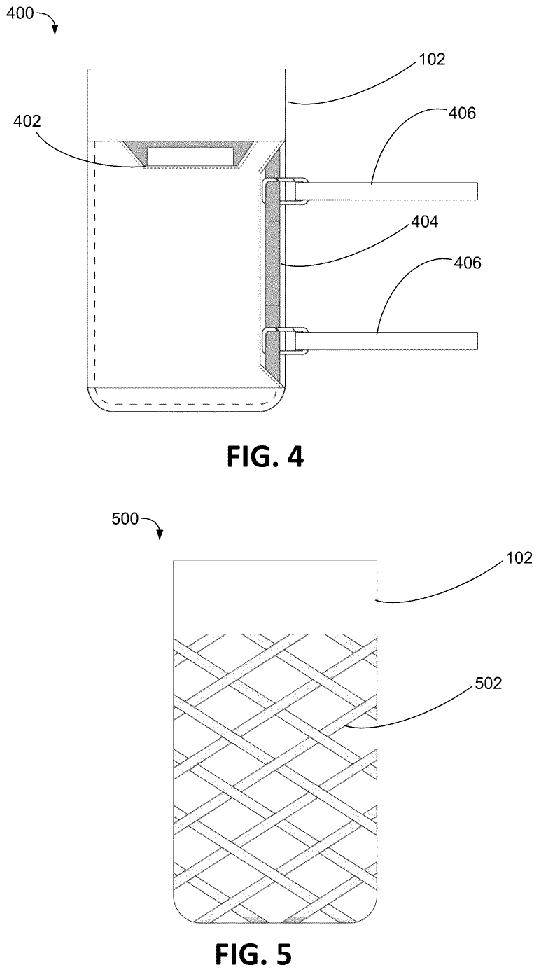

FIG. 4 illustrates yet another example configuration of the apparatus 400 according to some embodiments. FIG. 4 shows a rear view of the apparatus 400 according to some embodiments. The panel 102 includes a container portion 402, which can contain, for example, identification card(s). The first panel 102 includes an elastic band 404, which is configured to be able to hold straps, D-rings, or other similar devices. For example, FIG. 4 shows the elastic band 404 connected to straps 406 via a connector ring.

FIG. 5 illustrates yet another example configuration of the apparatus 500 according to some embodiments. FIG. 5 shows a rear view of the apparatus 500 according to some embodiments. The apparatus 500 includes a panel 102 that includes one or more elastic bands, straps, or material. According to some embodiments, the apparatus 500 includes a panel 102 that includes one or more elastic bands, straps, or material that form a weave configuration or pattern 502 (e.g., a web), wherein such weave configuration can hold for example, a water bottle.

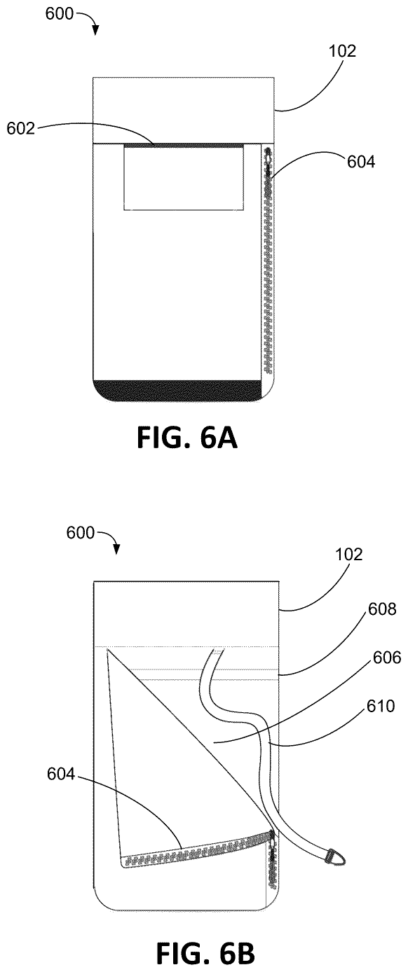

FIG. 6A and FIG. 6B show alternate configurations of another example of an apparatus 600. FIG. 6A illustrates rear view of the apparatus 600, where the panel 102 includes a first container portion 602. The first container portion 602 can be configured to hold for example, and identification card. The first container portion 602 can be or include a transparent portion which allows, for example, the contained identification card to be viewable. The panel 102 includes a second container portion which is shown to be in a closed state in FIG. 6A, and in an open state in FIG. 6B. The second container portion is closed via a zipper 604 as shown in FIG. 6A. FIG. 6B shows the zipper 604 in an open state, which provides access to the second container portion 606. Inside the second container portion 606, there is an elastic band 608 and a lanyard or strap 610 which can be used to connect a key, a D-ring, or other small devices.

As an example, one or more mobile devices which can be stored in the embodiments of the apparatus described herein can be or include a mobile phone, a smart watch, headphones, earphones, smart glasses, a smart ring, a tablet, etc., or any combination(s) thereof.

As an example, a locking mechanism to secure access to the opening of the container can include two opposing plates, one on a flap portion of the first panel, and another one on the second panel, positioned such that they can engage when the flap portion overlaps a portion of the second panel. The two opposing plates can be, for example, interlocking female and male components. That is, one of the plates is a female component, and the other one of the plates is the male component. The locking mechanism is configured to securely lock the opening such that any electronic device contained within the apparatus is inaccessible to a user until specific conditions are met. That is, the locking mechanism disengages under certain circumstances.

For example, the certain circumstances can be one or more conditions based on location or time. For example, the apparatus can securely contain a mobile electronic device during events (e.g., a show, a concert, a competition, a speech, a gala, an exam, etc.) The locking mechanism can be disengaged when the user exits the venue or after the event ends. Alternatively, a user might need to find venue staff to unlock the apparatus to gain access to their mobile electronic device.

According to some embodiments, the locking mechanism is configured to be controlled remotely. It may include electronic receivers like RFID, which respond to signals from a proximity transmitter when entering or leaving a specific area. For example, the locking mechanism can be configured to activate to unlock when the device is in a seating area and deactivate outside a venue.

According to some embodiments, the locking mechanism can include a microprocessor to receive a signal from a nearby beacon. Receiving a signal could trigger the lock to engage, restricting access to mobile electronic device(s) contained in the apparatus. Conversely, the absence of a signal might also activate the lock.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. An apparatus for securely storing one or more mobile electronic device(s), comprising:
a first panel;
a second panel,
wherein the first panel and the second panel are connected together to define a container body with an opening,
wherein the container body is configured for storing the one or more mobile electronic device(s),
wherein the first panel includes a flap portion configured to fold over the opening to cover the opening and at least a part of the second panel, and
the first panel includes at least a portion of a locking mechanism configured to securely lock the flap portion to the second panel.

2. The apparatus of claim 1,
wherein the portion of the locking mechanism is arranged at the flap portion.

3. The apparatus of claim 1,
wherein the second panel includes a mechanism configured to connect to the portion of the locking mechanism of the first panel.

4. The apparatus of claim 1,
wherein the first panel includes a container portion.

5. The apparatus of claim 1,
wherein the first panel includes a second container portion.

6. The apparatus of claim 1,
wherein the first panel includes a container portion with a transparent window.

7. The apparatus of claim 1,
wherein the second panel includes a container portion.

8. The apparatus of claim 1,
wherein the second panel includes a second container portion.

9. The apparatus of claim 1,
wherein the second panel includes a container portion with a transparent window.

10. The apparatus of claim 1,
wherein the first panel includes a mesh material.

11. The apparatus of claim 1,
wherein the second panel includes a mesh material.

12. The apparatus of claim 1,
wherein the second panel includes a perforated material.

13. The apparatus of claim 1, further comprising an elastic strap connected to the second panel.

14. The apparatus of claim 13, wherein the elastic strap forms or is a part of a weave pattern.
